(19) United States
(12) Patent Application Publication
(10) Pub. No.: US 2021/0089288 A1
(43) Pub. Date: Mar. 25, 2021

(54) SYSTEMS AND METHODS FOR ENVIRONMENT INSTANTIATION

(71) Applicant: FIDELITY INFORMATION SERVICES, LLC, Jacksonville, FL (US)

(72) Inventors: Scott MEYER, Jackson, WI (US); Siva Rama Mohan Allu, Frisco, TX (US)

(73) Assignee: FIDELITY INFORMATION SERVICES, LLC, Jacksonville, FL (US)

(21) Appl. No.: 17/014,718

(22) Filed: Sep. 8, 2020

Related U.S. Application Data
(60) Provisional application No. 62/904,613, filed on Sep. 23, 2019.

(51) Int. Cl. G06F 8/61; G06F 11/30; G06F 8/65

(52) U.S. Cl. CPC G06F 8/61; G06F 11/3051; G06F 2201/86; G06F 8/65; G06F 11/302

(57) ABSTRACT

Systems and methods are disclosed for generating and/or updating an environment, including receiving, from a user device, a request to establish an environment including identification of an application of the environment, generating a parameter based on the application, determining if the parameter is above a threshold; preparing a network for an interaction based on the parameter if the parameter is above the threshold, preparing a server to receive, store, and provide data for the application, and generating code based on the application for operation on the server. The parameter may be a network measure based on a capability of the application. The system and methods include monitoring the network to determine if the parameter is above a threshold, and updating the network if the parameter is above the threshold.

### RELATED APPLICATIONS

This application claims priority to U.S. Provisional Patent Application No. 62/904,613, filed on Sep. 23, 2019, the disclosure of which is incorporated by reference in its entirety.

### FIELD

The present disclosure relates generally to an environment instantiation platform, including apparatus, systems, and methods for generating, updating, and maintaining a virtual environment.

### BACKGROUND

A variety of software structures are used by a developer to supply a client with a desired platform capability for operation by a number of users. An application may be generated that provides the desired platform capability. The application may operate in an environment. The application may communicate with the network and/or one or more databases. The application may be managed over a server procured for the purpose of enabling the application. The virtual network, the number of servers, and the application may be prepared separately to support the desired capability.

Each step of the above process of setting up and managing the software structures requires a series tasks tailored to each client. One software development team may develop the application. Another software development team may procure servers for the operation of the application. Another software development team may generate a database. Another software development team may embed the applications on one or more hardware devices and manage the operation. Performing each of these tasks is a time-intensive and expensive endeavor. Further, when the platform cannot meet demand or is underused, many of these tasks must be repeated to adjust the software structures and/or the desired platform capability.

For example, a client may wish to set up a financial platform for its customers to access to accomplish a variety of financial transactions. A number of separate, time-consuming tasks may be required for each step of instantiating the financial platform, causing expense and wasted effort. Further, any updates to the financial platform, for example to add an application capability or increase capacity, results in further expense and time lost.

### SUMMARY

The inventive systems and methods may comprise multiple embodiments. In some embodiments, a system for generating an environment is described. The system comprises at least one platform and at least one non-transitory memory storing instructions to perform operations when executed by the at least one processor. The operations include receiving, from a user device, a request to establish an environment including identification of an application of the environment; generating a parameter based on the application; determining if the parameter is above a threshold; preparing a network for an interaction based on the parameter if the parameter is above the threshold; preparing a server to receive, store, and provide data for the application; and generating code based on the application for operation on the plurality of devices. In some embodiments, the operations may further comprise generating an end-user interface based on the application. In some embodiments, the parameter may be a network measure based on a capability of the application. In some embodiments, the environment may operate on a virtual network that includes at least one of a management interface, a testing interface, and a development interface. In some embodiments, the operations may further comprise monitoring the network to determine if the parameter is above a threshold, and updating the network if the parameter is above the threshold.

In some embodiments, a system for updating and/or modifying an environment is described. The system comprises at least one processor and at least one non-transitory memory storing instructions to perform operations when executed by the at least one processor including: receiving an identification of an application capability from a user interface, determining an infrastructure parameter based on the application capability, generating a platform based on the application capability, and configuring the environment based on the infrastructure parameter. In some embodiments, the operations may include monitoring an event of the environment and updating the configuration of the environment based on the event. In some embodiments, the event may be exceeding a load capacity of the environment. In some embodiments, the operations may include monitoring a load capacity of the environment, and updating the configuration of the environment based on the load capacity. In some embodiments, the operations may include monitoring the use of the application capability of the system to determine the use of a resource; and updating the resource based on the use of the application capability. In some embodiments, the operations may include monitoring the use of the application capability of the system to determine the use of a resource, and determining an update for the resource based on the use of the application capability, and sending the update to the user interface. In some embodiments, the infrastructure parameter is a server configured to rout packets and provide a communication protocol for the application capability.

In some embodiments, a method for generating a platform is described. The method including steps of receiving an identification of an application capability from a user interface, determining an infrastructure parameter based on the application capability, generating an environment based on the application capability; and configuring the environment based on the infrastructure parameter. In some embodiments, the steps may include monitoring an event of the environment and updating the configuration of the environment based on the event. In some embodiments, the event may be exceeding a load capacity of an infrastructure associated with the environment. In some embodiments, the steps may include monitoring a use of an application in another environment associated with a second user and sending an update to the user interface to update the environment with the application. In some embodiments, the steps may include monitoring the use of the application capability of the system to determine the use of a resource, and updating the resource based on the use of the application capability. In some embodiments, the steps may include monitoring the use of the application capability of the system to determine the use of a resource, determining an update for the resource based on the use of the application capability, and sending the update to the user interface.

Embodiments including methods and computer-readable media implementing the above embodiments are also disclosed herein.

The foregoing general description and the following detailed description are example and explanatory only and are not restrictive of the claims.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in and constitute a part of this specification, illustrate several embodiments consistent with the disclosure and, together with the description, serve to explain the principles of the disclosure. In the drawings:

FIG. 1 illustrates an exemplary embodiment of a network for connecting devices.

FIG. 2A illustrates a schematic of an exemplary embodiment of a system for generating, updating, and/or maintain an environment.

FIG. 2B illustrates a schematic of an exemplary embodiment of a system for generating an environment.

FIG. 2C illustrates a schematic of an exemplary embodiment of a system for maintaining and/or updating an environment.

FIG. 3 illustrates a schematic of an exemplary embodiment of a virtual network.

FIG. 4 illustrates a block diagram of an exemplary embodiment of a method of generating an environment.

FIG. 5 illustrates a block diagram of an exemplary embodiment of a method of updating an environment.

FIGS. 6A-6C illustrate exemplary embodiments of a user interface.

FIG. 7 illustrates an exemplary embodiment of a user interface.

### DETAILED DESCRIPTION

Reference will now be made in detail to exemplary embodiments, some examples of which are shown in the accompanying drawings.

It is understood that while certain embodiments are discussed to facilitate understanding of various principles and aspects of this disclosure, the embodiments are not described in isolation and the descriptions are not necessarily mutually exclusive. Thus, it is contemplated and understood that described features of principles of any embodiment may be incorporated into other embodiments.

Exemplary disclosed embodiments include apparatus, systems, and methods for generating, updating, and/or maintaining an environment via an environment instantiation platform. The environment instantiation platform may include a control plane and an environment. The control plane may be configured to generate and/or manage the environment. The control plane may be configured to embed one or more computer programs on a hardware component. The environment may be tailored to generate code for an application, a communication protocol, a database, and/or a network. The environment may be used to operate software programs for a desired capability. A user may input a desired capability of the environment and/or an infrastructure requirement into a user interface associated with the environment instantiation platform. The desired capability may be a software service solution, a partner provider, and/or a software service component. The software service solution may be linked to a number of software service components. The partner provider may be linked to a number of interfaces associated with one or more software service components. The software service solution may be an application. The software service solution, software service provider, and/or software service component may be associated with a metadata file that may select one or more software service components. For example, selection of a software service solution may link to a metadata file that selects one or more applications required to operate the software service solution. As another example, selection of a software service component may link to a metadata file that selects one or more other software service components required for the software service component to operate. The software service solution, partner provider, and/or component may be associated with a policy parameter. The user may input the policy parameter. The control plane may include an application programming interface to receive the inputs from the user interface.

The application programming interface may execute instructions associated with generating and/or selecting one or more software service components based on input received via the user interface. The application programming interface may determine a policy parameter associated with the desired capability and/or from an input from the user. The application programming interface may compare the determined policy parameter to a known parameter to determine the viability of the selected software services component. The selected software services component may be compared to a database including a stored software service component. In some embodiments, the application programming interface may be configured to adopt one or more database software service components and/or one or more selected software service components into the environment. The application programming interface may use the determined policy parameter to designate an infrastructure for the environment. The infrastructure may include a server.

For example, a financial institution may request a financial service software program where a number of users may interact with the financial institution. The financial institution may interact with a user interface associated with an environment instantiation platform to select a desired capability for an environment associated with the financial service software program. The financial institution may choose to select or not select a user interface button associated with a desired capability. The desired capability may be associated with a policy parameter, and the financial institution may input the desired parameter when prompted by the user interface. The application programming interface may determine a software service component based on the user interface button associated with the desired capability and/or the policy parameter. The desired capability may be a banking system. The policy parameter may be a number of expected users. The application programming interface may select software service components including, for example, a user login service, a bank account balance service, a money transfer service, a subscription service, and/or a rewards program service. The application programming interface may be configured to compare the selected components associated with the financial service to existing software service components in a database. The application programming interface may be configured to generate code for a new software service component based on the selection of the software service components. The application programming interface may compare the policy parameter to a policy check to determine if the selected software service components may operate within the environment.

The application programming interface may generate code for an environment based on the selected software service component and/or the database software service component. The generated code may install, manage, and/or execute programs associated with the environment. The generated code may allow one or more devices to install computer programs and/or databases associated with the environment to maintain and operate the environment. The application programming interface may select an application based on the one or more available software service components. The application programming interface may be configured to generate code for the application based on a new software service component. The application programming interface may be configured to conduct a policy check. The policy check may be to determine whether the determined software service components and/or the new software service components may operate within the environment.

The component selection input from the user interface may be associated with an infrastructure requirement or a capability requirement. The application programming interface may configure the environment based on communication with at least one of a capability provider and/or an infrastructure provider. the application programming interface may store a template from one or more infrastructure and/or capability providers in a component database. The application programming interface may communicate with one or more infrastructure and/or capability providers to determine the polices of one or more software service components. The application programming interface may communicate with one or more infrastructure and/or capability providers to inform the providers of a tenant. The application programming interface may communicate with one or more infrastructure and/or capability providers to validate the environment. The application programming interface may communicate with one or more infrastructure and/or capability providers to convey a script and/or a declarative definition associated with one or more selected services components.

The environment may be configured to operate on a number of devices appropriate to the infrastructure requirement. The number of devices may be configured to support the desired capability. The application programming interface may be used in a virtual environment so that it meets the desired capability.

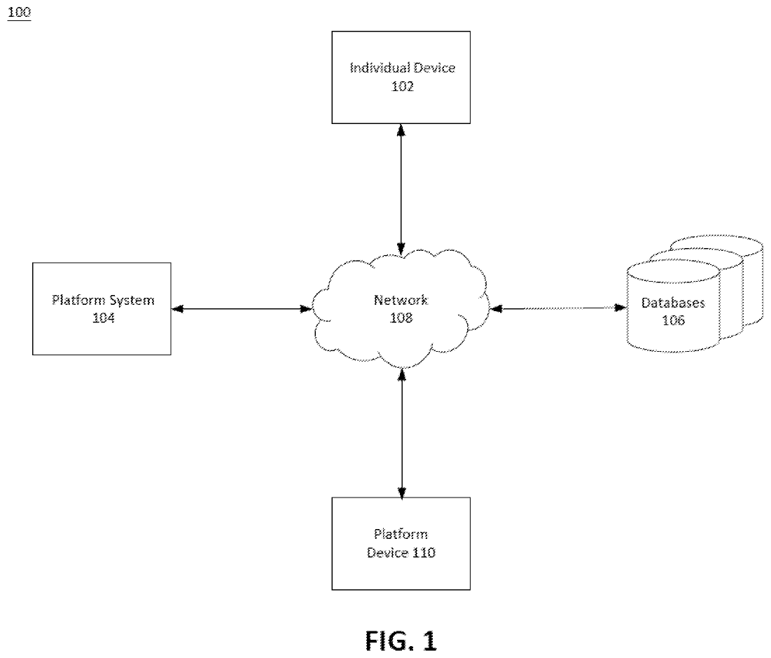

FIG. 1 is a schematic diagram of a system 100 for generating an environment via an environment instantiation platform consistent with disclosed embodiments. As depicted in FIG. 1, system 100 may include individual device 102, platform device 110, platform system 104, and databases 106 connected by network 108.

Individual device 102 may be any device associated with an individual, e.g., a user or an individual associated with configuring the environment. For example, device 102 may be a computer, smart device, phone, tablet, wearable device, etc. through which the user may interact with system 100.

Individual device 102 may include one or more computing devices configured to perform operations consistent with disclosed embodiments. For example, individual device 102 may include at least one of a desktop computer, a laptop, a server, a mobile device (e.g., tablet, smart phone, etc.), a wearable computing device, or other type of computing device. Individual device 102 may include one or more processors configured to execute software stored as instructions in memory. Individual device 102 may implement software to perform Internet-related communication and content display processes. For instance, individual device 102 may execute browser software that generates and displays interfaces, including content, on a display device included in, or connected to, individual device 102. Individual device 102 may execute applications that allow individual device 102 to communicate with components over network 108, and generate and display content in interfaces via a display device included in individual device 102. The disclosed embodiments are not limited to any particular configuration of individual device 102. For instance, individual device 102 can be a mobile device that stores and executes mobile applications that interact with databases 106 and network 108 to perform aspects of the disclosed embodiments, such as configuring an environment based on a desired capability. In certain embodiments, individual device 102 may be a device associated with a system, e.g., a personal computer, an interactive device, or similar, configured to be accessed and used by an individual. For example, individual device 102 may be used by a financial service institution to generate an environment to offer a desired capability to one or more users. The financial service institution may interact with a user interface to generate, manage, and/or update the environment.

Individual device 102 may be configured to receive input from the individual via an application or program running on the device. In other embodiments, device 102 may enable the individual to conduct business through a web browser running on the device. Via device 102, the individual may input parameters and interact with a system to identify a desired capability for an environment. For example, the individual may input a desired number of customers and/or manage the environment.

Platform system 104 may be a computing device capable of processing, routing, and/or receiving data, such as a personal computer (e.g., a desktop, laptop, workstation, or the like); server, a cloud computing environment or a virtual machine (e.g., virtualized computer, container instance, etc.); or a special-purpose computing device, such as a specialized server or computer (e.g., a network appliance, or the like). In some embodiments, platform system 104 may be a host service that manages one or more virtual servers on a variety of platforms over a network. For example, platform system 104 may be a server for a software service associated with a financial institution. As a further example, a financial institution may operate and/or manage platform system 104 to support an environment for an institution, such as financial service programs and applications for a financial service institution.

Platform system 104 may be configured to interact with the various elements of system 100. In some embodiments, platform system 104 may be configured to receive data associated with individuals and transmit this received data to databases 106. In some embodiments, platform system 104 may be configured to retrieve data associated with one or more individuals from databases 106 and may analyze, process, and/or route the retrieved data.

Platform system 104 may be configured to route data associated with an individual's interactions with the platform. For example, platform system 104 may communicate with a financial service system associated with a financial institution to relay data of a transaction.

Databases 106 may be one or more databases associated with the platform. Databases 106 may receive data from platform system 104. For example, data may be collected during the individual's interactions with the environment and may be transmitted to databases 106 via network 108. Databases 106 may include one or more computing devices configured to provide data to one or more of platform device 110 or network 108 and to receive data from individual device 102. In some aspects, such data can include data related to an individual's interactions with and transactions with the environment. Data stored by databases 106 may include data related to desired capabilities of an environment, application capabilities, policies to compare to a parameter input by a user, infrastructure indexing, and capability indexing. While databases 106 are shown separately, in some embodiments databases 106 may be included in or otherwise related to one or more of platform system 104 and/or platform device 110.

Network 108 may be any type of network configured to provide communications between components of system 100. For example, network 108 may be any type of network (including infrastructure) that provides communications, exchanges information, and/or facilitates the exchange of information, such as the Internet or other suitable connection(s) that enables the sending and receiving of information between the components of system 100. In some embodiments, one or more components of system 100 can communicate through network 108. In various embodiments, one or more components of system 100 may communicate directly through one or more dedicated communication links.

Platform device 110 may include one or more computing devices configured to interact with an environment generated for the individual (e.g., via individual device 102). Platform device 110 may be a device associated with the environment. For example, platform device 110 may include at least one of a desktop computer, a laptop, a server, a mobile device (e.g., tablet, smart phone, etc.), a gaming device, a wearable computing device, or other type of computing device. Platform device 110 may include one or more processors configured to execute software stored as instructions in memory. Platform device 110 may implement software to perform Internet-related communication and content display processes. For instance, platform device 110 may execute browser software that generates and displays interfaces, including content, on a display device included in, or connected to, platform device 110. Platform device 110 may execute applications that allow platform device 110 to communicate with components over network 108 and generate and display content in interfaces via a display device included in platform device 110. The disclosed embodiments are not limited to a certain configuration of platform device 110. For instance, platform device 110 may be a mobile device that stores and executes mobile applications that interact with databases 106 and network 108 to perform aspects of the disclosed embodiments, such as interacting with the environment. For example, a user may access an environment on platform device 110 generated, maintained, and/or prepared by an environment instantiation platform to perform a number of tasks associated with the financial service institution such as accessing a bank account, accessing a rewards program, or transferring money.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

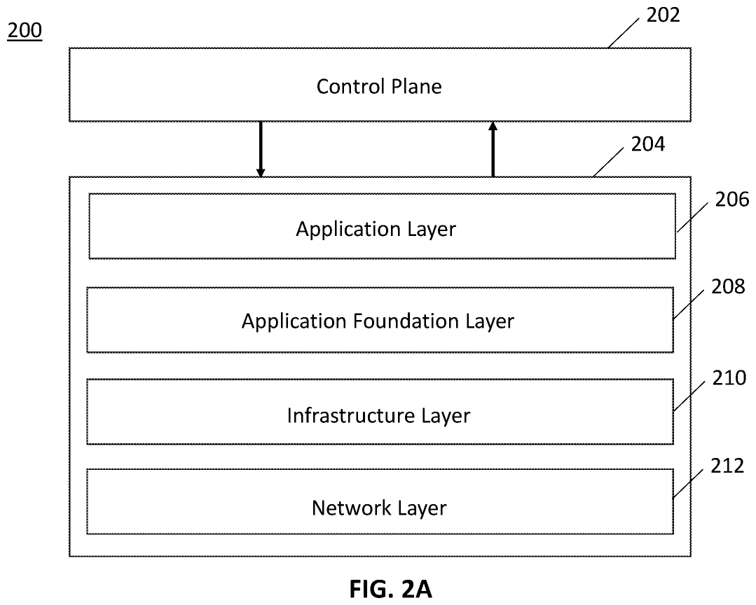

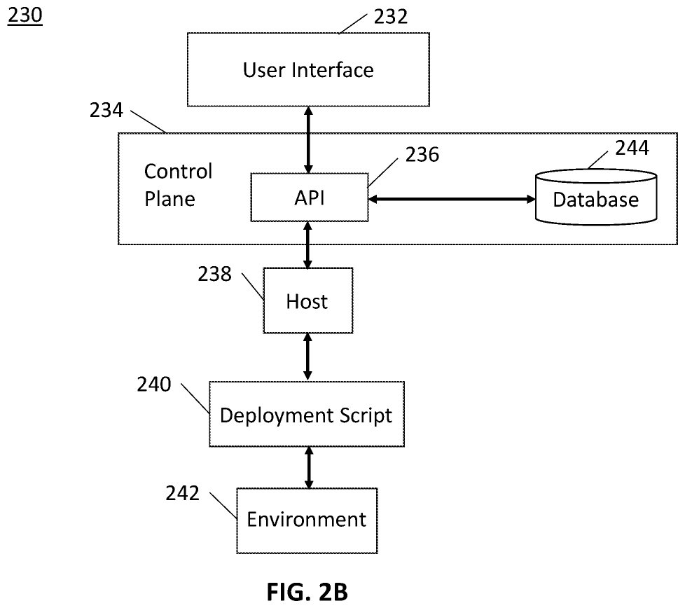

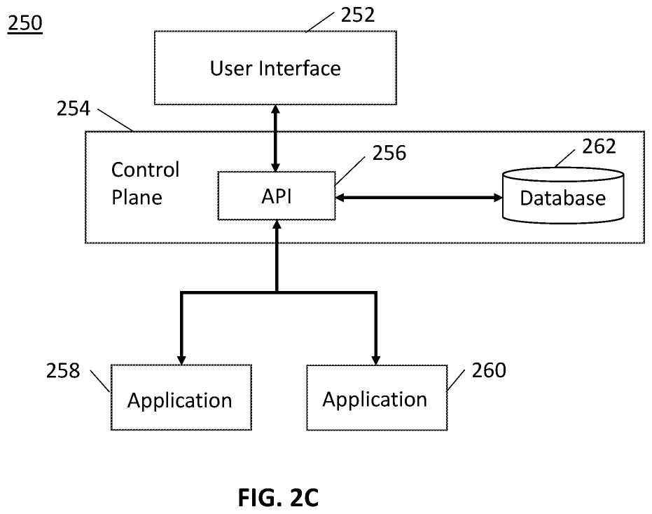

FIG. 2A is a schematic diagram of a system 200 for generating, updating, and/or managing an environment via an environment instantiation platform. System 200 may include control plane 202 and environment 204. Control plane 202 may generate environment 204 according to an input from a user interface. The user interface may operate on individual device 102. Control plane 202 may manage environment 204 by monitoring a parameter or an event of environment 204. Monitoring the parameter may include determining whether a load capacity of a server (e.g. platform system 104) has been exceeded. Monitoring the parameter may include determining, for example, whether a load capacity of a server (e.g. platform system 104) has exceeded a threshold level for a period of time.

Environment 204 may include one or more of application layer 206, application foundation layer 208, infrastructure layer 210, and network layer 212. Application layer 206 may include a user interface and a protocol used configured to receive an instruction from the user and/or display a result generated by. Application layer 206 may operate on a device for a user such as platform device 110. Application layer 206 may receive instructions from the user via the user interface and transmit the instructions via the protocol to a network associated with control plane 202, a database associated with the control plane (e.g., database 104), and/or a device associated with the environment (e.g., platform system 104, platform device 110). For example, for a financial service institution, application layer 206 may include an application associated with managing an environment and/or an application associated with a use by a user. The application associated with managing the environment may include, for example, a data routing application, a data storage application, an institution insight application, an application for monitoring data usage, or an application that monitors logins. The application associated with the use by the user may include, for example, a user login application, an identity management application, a mobile banking application, a rewards application, a consumer insight application, a bill pay application, a digital wallet application, and a risk and fraud application.

Application foundation layer 208 may operate as a local management resource for application layer 206, infrastructure layer 210, and network layer 212. Application foundation layer 208 may monitor application layer 206 including the use of an application, the performance of the application, and/or the communication of the application with infrastructure layer 210. Application foundation layer 210 may include one or more computer programs including a computer program to manage a packet transfer, a computer program to provision storage for an application, a computer program to prepare a namespace, a computer program to create and/or maintain configuration data.

Infrastructure layer 210 may operate as a data processing and storage resource for application foundation layer 208, application layer 210, and network layer 212. Infrastructure layer 210 may be configured to store and process data. The data may be associated with the application. Infrastructure layer 210 may include one or more computer programs including a computer program to generate and/or manage a relational database, a computer program to generate and/or manage a communication node, a computer program to monitor the use of an application by one or more users, a computer program to generate and/or manage security features for data and/or communications, and a computer program to generate and/or manage a file storage system.

Network layer 212 may be used as a packet forwarding resource by application layer 202, application foundation layer 204, and infrastructure layer 206. Packets may be forwarded from a computer program on one layer to a computer program on another layer via one or more routers. Network layer 210 may a computer program to generate, update, and/or manage a virtual private cloud, and/or a computer program to generate, update, and/or manage a virtual network.

FIG. 2B is a schematic diagram of a system 230 for generating an environment consistent with disclosed embodiments. System 230 may include user interface 232 and control plane 234. In some embodiments, control plane 234 may be implemented as described above with respect to control plane 202. Control plane 234 may include API 236. API 236 may receive inputs from user interface 232. The inputs may include the selection of one or more software service components. Software service components may comprise, in some embodiments, a software application. The inputs may include the identification of one or more tenants. API 236 may send an instruction to user interface 232 to request an input. The instruction for the input may be based on a metadata file associated with a software service component. The metadata file may be a descriptor file of the software service component including instructions and data for installing and/or provisioning one or more resources in the environment. The metadata file may include one or more attribute. The inputs may be one or more requirements of the selected software service components and/or one or more requirements associated with the identified tenants. API 236 may communicate with database 244 to select a second software service component based on or more inputs from user interface 232, for example, if the second software service component is related to the selected software service component or if the second software service component is required for the first software service component to function.

In some embodiments, API 236 may communicate with database 244 to select an existing environment based on the selection of software service components from user interface 232. In such embodiments, the existing environment may be modified based on inputs from user interface 232.

API 236 may provide the metadata file to host 238. Host 238 may generate code associated with a selected software service component. Host 238 may communicate with a script deployment service to deploy environment 242. Environment 242 may include one or more software service components. In some embodiments, environment 242 may be implemented as described above with respect to environment 204.

FIG. 2C is a schematic diagram of a system 250 for managing an environment consistent with disclosed embodiments. System 250 may include user interface 252 and control plane 254. In some embodiments, control plane 234 may be implemented as described above with respect to control plane 202. Control plane 254 may include API 256. API 256 may manage an environment including one or more software service components. API 256 may manage application 258 and application 260 of environment 264. In some embodiments, API 256 may communicate with one application of environment 264 to manage another application. API 256 may receive inputs from application 258 and application 260 based on a usage of environment 264, including usage of one or more network components, one or more databases, and/or one or more software service components. API 256 may communicate with database 262 to select one or more updated software service components. API 256 may send a request for input to user interface 252 based on inputs from application 258 and application 260. For example, application 260 may monitor a usage of application 258 and communicate the usage to API 256. In this example, API 256 may update infrastructure provisioning based on the usage. In some embodiments, a software service component may be used to monitor a metric and/or an event. In some embodiments, a software service component may generate insights based on a use and/or a lack of use of a feature of one or more software service components. In some embodiments, an application may generate insights based on a use of a feature of one or more software service components by an environment similar to environment 264 used by another institution. In some embodiments, a software service component may be used to update an environment via infrastructure provisioning and/or communication with one or more components of the environment. In some embodiments, a software service component may be configured to modify a tenant of an environment. In some embodiments, a software service component may be configured to monitor, manage, and/or adjust costing associated with the environment.

Control plane 254 may include an API, similar to API 234 or 236, that may be used for an existing environment to update a version of the existing environment.

In some embodiments, control plane 234 of system 230 may be the same control plane 254 of system 250. In such embodiments, the combined control plane may include API 236 and API 256 consistent with the embodiments described herein such that the combined control plane may be used to both generate and manage an environment. In some embodiments, user interface 232 of system 230 may be the same user interface 252 of system 250 such that the combined user interface may be used to both generate and manage an environment.

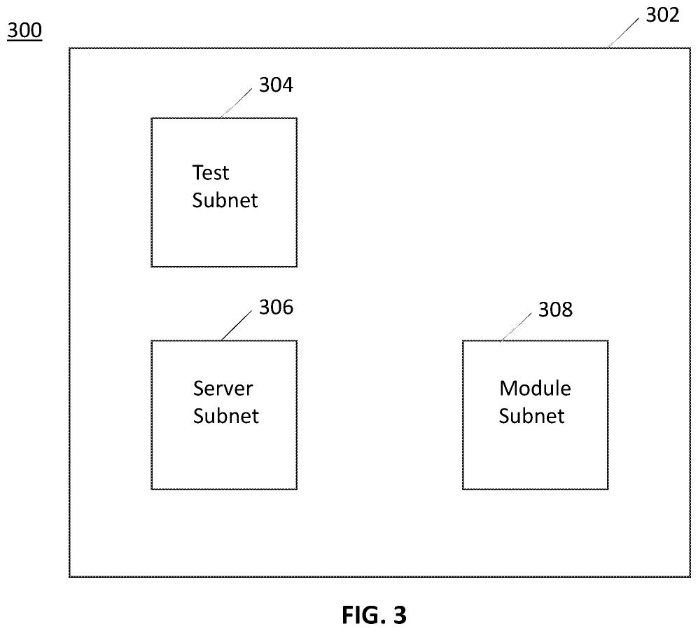

FIG. 3 is a schematic diagram of a system 300 for operating an environment consistent with disclosed embodiments. As depicted in FIG. 3, system 300 may include individual device virtual network 302 associated with an environment that may operate on a platform system (e.g., platform system 104), an individual device (e.g., individual device 102), or platform device (e.g., platform device 110). Virtual network 302 may include test subnet 304, server subnet 306, and module subnet 308. Virtual network 302 may include interfaces for subnets to interface. Subnets 304, 306, and 308 may operate to manage a capability of the environment. Virtual network 302 may enable communication between multiple personal computers, virtual machines, virtual servers, or similar devices. Virtual network 302 may operate on a network layer (e.g., network layer 212). Virtual network 302 may allow each platform device (e.g., platform device 110) to access a function of the environment. Virtual network 302 may be accessed remotely to update, modify, or test the function of subnets 304, 306, 308.

A subnet (e.g., test subnet 304, server subnet 306, module subnet 308) may be a subdivision of virtual network 302. Test subnet 304 may be configured to operate one or more software services component to test the software services component for operation on virtual machines that function as one or more layers of an environment (e.g., environment 204). Server subnet 306 may be configured to manage a database associated with an institution. The database may be a relational database. Module subnet 308 may be configured to manage one or more applications. Module subnet 308 may be configured to deploy and/or manage clusters. Module subnet 308 may be configured to deploy and/or manage a virtual cluster associated with a physical cluster. Module subnet 308 may be configured to manage, store, and/or retrieve data from a database. Module subnet 308 may be configured to route traffic, retrieve and/or manage resources for a user, and/or securely transfer data. Module subnet 308 may be configured to install one or more applications. Module subnet 308 may be configured to store data from a user. Module subnet 308 may communicate with server subnet 306 to request data from the database. Data requested from the database may be used by the one or more applications. Module subnet 308 may communicate with a server outside of virtual network 302. The server outside of virtual network 302 may be configured to manage one or more virtual network rules and/or service endpoints.

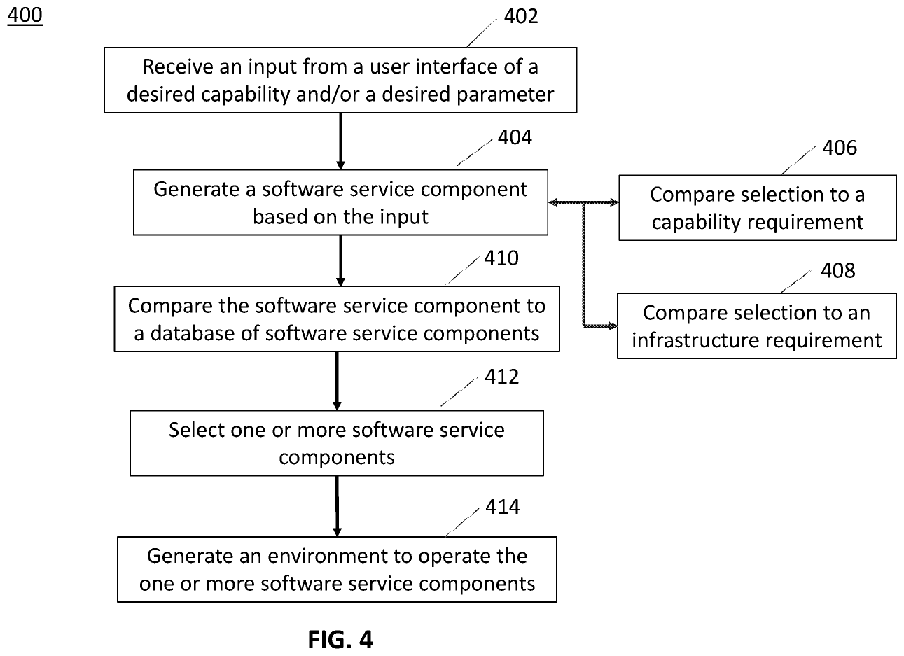

FIG. 4 is a block diagram of a method 400 for an exemplary embodiment of generating an environment. Method 400 may operate on devices of a virtual network (e.g., virtual network 302) associated with an environment that may operate on a platform system (e.g., platform system 104), an individual device (e.g., individual device 102), a platform device (e.g., platform device 110), or a network (e.g., network 108). Certain steps of method 400 may be completed across a network (e.g., network 108) on a number of exemplary devices. Consistent with disclosed embodiments, method 400 may include steps 402-414. In some aspects, the steps of method 400 may be combined, omitted, reordered, and/or integrated into other processes to perform the tasks contemplated herein.

At step 402, a processor of an individual device (e.g., individual device 102) may receive an input via a user interface for a desired parameter and/or a desired capability. The desired parameter may be a number of users and/or a number of accounts. It is contemplated that other parameters are possible including a size of upload and/or download over a period time, a number of logins, a number of servers, a volume of traffic, or any other known parameters associated with an infrastructure requirement. The volume of traffic may be based on an expected use (e.g., download size over a period of time, upload size over of a period of time). The desired capability may be associated with a functionality of an application. For example, the functionality of the application may be consistent with the application functionality associated with a financial service institution discussed above.

At step 404, an application programming interface may generate a software service component based on the input from the user interface. The application programming interface may operate on one or more devices associated with a software services institution that communicate with an individual device 102. The application programming interface may operate on one or more devices associated with a software services institution that communicate with an individual device 102. The application programming interface may select a software services component based on the input from the user interface. The application programming interface may use a relational database to determine the software services component based on the desired capability and/or the desired parameter. The application programming interface may generate a software services component based on the desired capability and/or the desired parameter. In some embodiments, the application programming interface may receive a selection of the software services component from the user interface. If more information is required to generate a software service component selection, step 404 may terminate and/or return to step 402 to request more information via the user interface.

At step 406, the application programming interface may compare the selection of software services to a capability requirement. The capability requirement may be a policy check stored in a database. The application programming interface may determine whether the capability requirement is satisfied such that the software service selection may operate in the environment. The application programming interface may determine whether a first selected software service component is compatible with a second selected software service component.

At step 408, the application programming interface may compare the selection of software services to an infrastructure requirement. The infrastructure requirement may be a policy check stored in a database. The infrastructure requirement may be received from an infrastructure provider. The application programming interface may determine whether the infrastructure requirement is satisfied such the software service selection may operate in the environment. The application programming interface may determine whether the infrastructure requirement is satisfied based on an infrastructure parameter. The application programming interface may determine whether a first selected software service component and a second software service component together satisfy the infrastructure requirement.

At step 410, the application programming interface may compare the selected software service component to a database of software service components. If a parameter of a database software service component is similar to the parameter of the selected software service component, the application programming interface may replace the selected software service component with the database software service component. In some embodiments, the application programming interface may request whether an updated parameter and/or capability based on the database software service component is accepted via the user interface.

At step 412, a processor may configure a platform based on the desired parameter and/or the desired capability. If the application programming interface replaces the selected software service component with the database software service component, the application programming interface may communicate the updated parameter and/or capability based on the database software service component to the user interface

At step 414, the application programming interface may generate an environment (e.g., environment 204) to operate the selected software service component. The application programming interface may execute and/or install a number of computer programs on one or more devices for the platform (e.g., platform device 110, platform system 104) to perform tasks of a logical subdivision (e.g., layers 206, 208, 210, and 212) of an environment (e.g., environment 204). For example, the processor may generate and/or execute code for a program on a number of servers and/or devices. The application programming interface may be configured to generate a communication protocol on one or more devices for the platform. The application programming interface may be configured to install an application on a device (e.g., platform device 110).

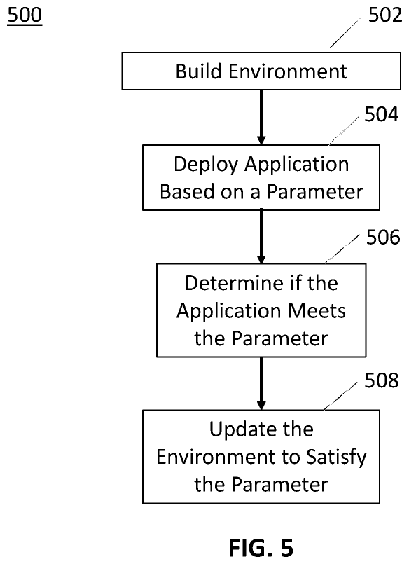

FIG. 5 is a block diagram of method 500 for an exemplary embodiment of generating a platform. Method 500 may operate on devices of a virtual network (e.g., virtual network 302) associated that may operate on a platform system (e.g., platform system 104), an individual device (e.g., individual device 102), or platform device (e.g., platform device 110). Method 500 may operate across a network (e.g., network 108) on a number of exemplary devices. Consistent with disclosed embodiments, method 500 may include steps 502-508. In some aspects, the steps of method 500 may be combined, omitted, reordered, and/or integrated into other processes to perform the tasks contemplated herein.

At step 502, a processor associated with a platform system (e.g., platform system 104) may receive an instruction to prepare an environment on one or more devices (e.g., platform device 110, platform system 104). The environment may be generated based on a desired capability and/or a desired parameter. The environment may allow one or more users to interact with a network (e.g., network 108) via an application to accomplish the desired capability.

At step 504, a processor associated with a platform system (e.g., platform system 104) may generate a software service component on one or more devices (e.g., platform device 110, individual device 102) based on the input from the user interface. The input may be a desired capability or an infrastructure parameter. The software service component may be associated with the infrastructure parameter. When selected, the software service component may define an input of the infrastructure parameter in order to operate alone and/or with one or more other software service components. The infrastructure parameter may be a number of users and/or a number of accounts. It is contemplated that other parameters are possible including a size of upload and/or download over a period time, a number of logins, a number of servers, a volume of traffic, or any other known parameters associated with an infrastructure requirement. The volume of traffic may be based on an expected use (e.g., download size over a period of time, upload size over of a period of time). The desired capability may be a selection of software services consistent with the software services described herein.

At step 506, a processor associated with a platform system (e.g., platform system 104, platform device 110) may determine whether the deployed application meets the identified parameter. The processor may be configured to conduct a load test on the application. The processor may be configured to measure a use of the application over a period of time. The processor may compare a tested usage and/or a measured usage to an identified usage.

At step 508, the processor associated with a platform system (e.g., platform system 104) may update the environment according platform. If the deployed application exceeds the identified parameter, the processor may update an environment parameter based on the determination of whether the tested usage and/or the measured meets the identified usage. The updated environment parameter may be used to reconfigure the environment to meet the updated environment parameter. For example, the environment may be updated to operate on a smaller number of devices (e.g., platform device 104) if the measured usage is less than the identified usage. In such an example, the environment may be disassociated from a device (e.g., platform device 104), and one or more programs may be uninstalled from the device. As another example, the environment may operate on one or more server services, and the environment may be updated to use more or less of As another example, the environment may be updated to a larger number of devices where the measured usage exceeds the identified usage. In such an example, the environment may provision one or more devices. It is contemplated that the processor may report the measured usage and/or the tested usage to a user device (e.g., individual device 102, platform device 110).

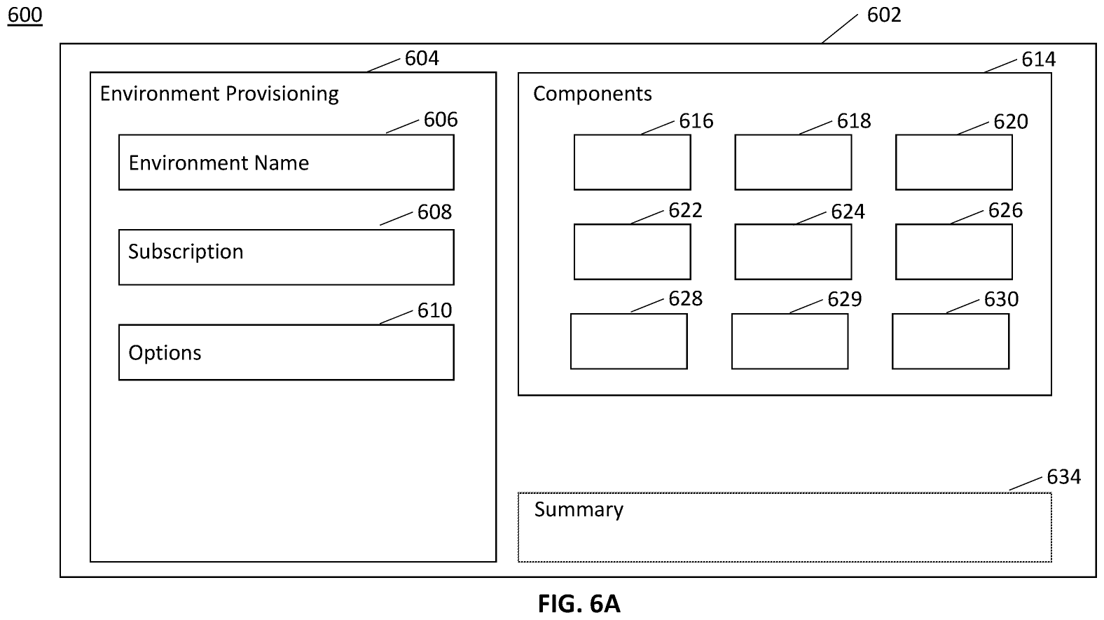

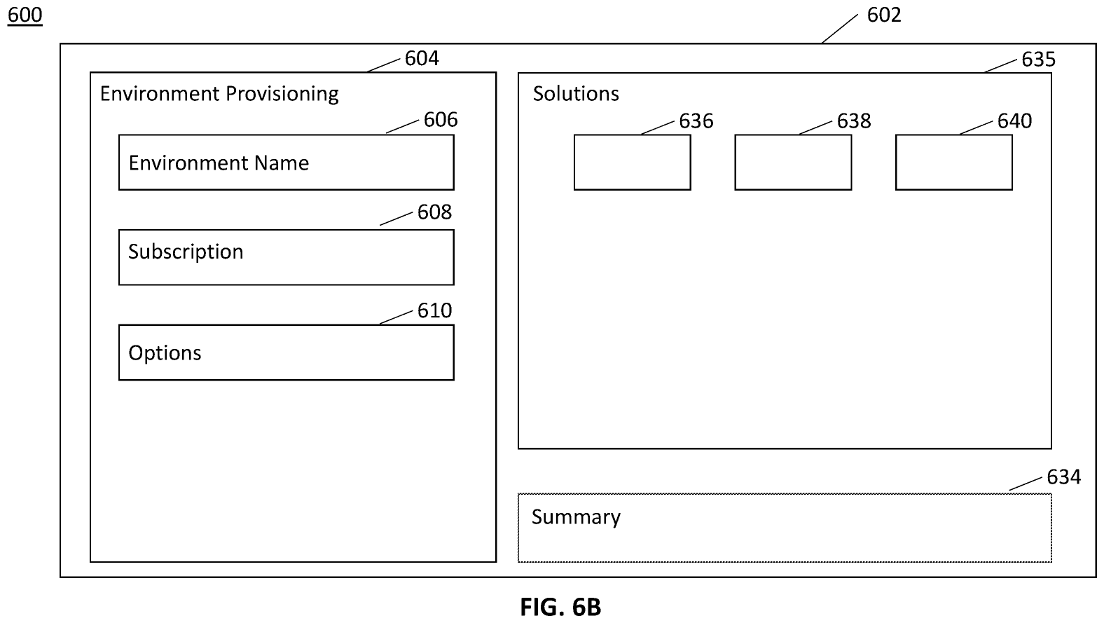

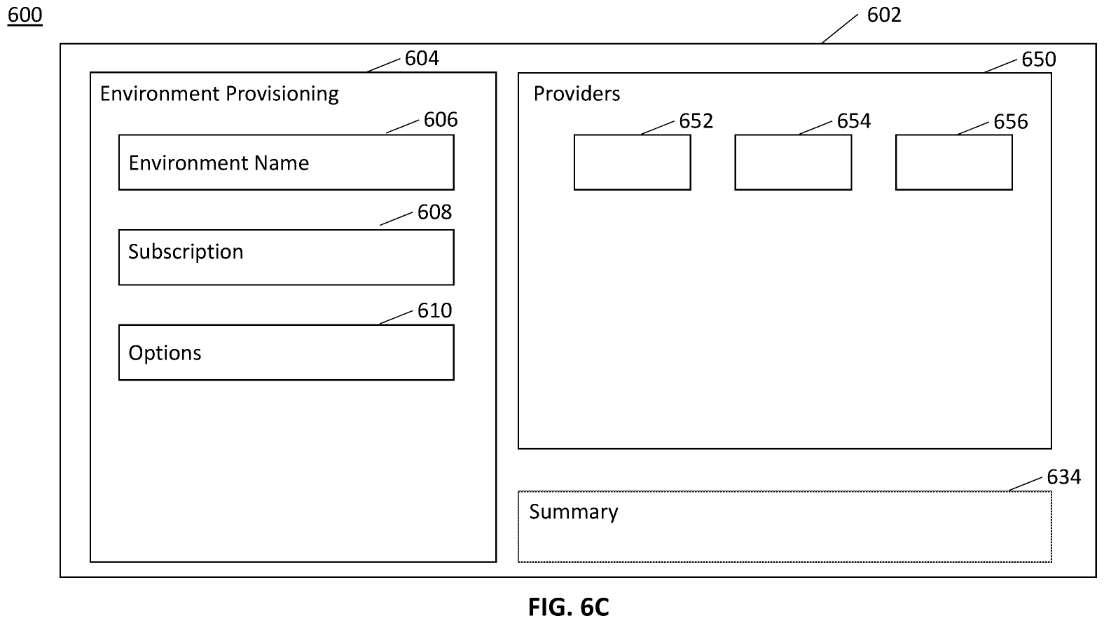

FIGS. 6A-6C illustrate exemplary embodiments of a user interface associated with generating an environment. The user interface may be part of an application installed on a computing device (e.g., individual device 102). It is contemplated that the user interface may be implemented as part of a website or web portal that can be accessed by a user, for example, when the user uses a browsing application.

FIG. 6A illustrates user interface 600 displaying information related to generating an environment. User interface 600 may include selection interface 602. Selection interface 602 may include environment provisioning section 604, component section 614, and summary 634. Environment provisioning section 604 may include input sections, such as environment name input 606, subscription input 608, and options input 610. Environment name input 606 may be used to select a name. Subscription input 608 may be used to select a type of subscription, such as a local computing service or a cloud computing service. Options input 610 may be used to select options associated with one or more software service components, software service solutions, and/or partner providers.

Component section 614 may include a number of selectable component buttons 616-630. Selectable component buttons may include: a button associated with an application programming interface (“API”) catalog; a button associated with an identity and access management system; a button associated with a system for accessing a system via a local computer, a midrange computer, or a mainframe server; a button associated with a database of customer and arrangement information and/or a rewards program; a button associated with a deposit system; a button associated with a database of enterprise affiliations within the enterprise, for example, enterprise branches or offices; a button associated with one or more banking modules; a button associated with a multi-channel transaction switching platform; a button associated with a data management system; a button associated with a financial card management system; a button associated with a center for managing images; and/or a button associated with a bill pay system.

In some embodiments, the selection of a selectable button associated with a number of options or capabilities may generate a new option to select a new button associated with different options or capabilities. In some embodiments, selection of a selectable button may generate a screen requesting more information for the selectable button. In some embodiments, one or more buttons may be exclusive to other options and that two such buttons may not both be selected at the same time.

Once one or more buttons is selected from component section 614, options section 610 may provide input selections related to options or requested information for the selected component. For example, if selectable button 618 is selected, where selectable button 618 is associated with a user identity and management system, options section 612 may include options or requested information related to the user identify and management system. In this example, options section 612 may request a number of users and/or a number of accounts to be used in the user identity and management system. Also in this example, options section 612 may include selections for further capabilities for the users and/or accounts.

Summary section 634 may include a list of selected components and associated information. Summary section 634 may include information from Options input 610.

FIG. 6B illustrates an aspect of user interface 600. Certain features of user interface 600 are not shown or discussed in these examples where such features may be similar to those discussed for other embodiments.

Selection interface 602 may include solution selection 635. Solution selection 635 may include a number of buttons 636-640 for selecting a solution that an institution selects to implement in the environment. Selectable button 636 may be associated with a deposit system and/or a button associated with a system of one or more banking modules. Selecting a solution may select one or more component buttons (e.g., 616-630) or one or more provider buttons.

FIG. 6C illustrates an aspect of user interface 600. Certain features of user interface 600 are not shown or discussed in these examples where such features may be similar to those discussed for other embodiments.

Selection interface 602 may include provider selection 650. Provider selection 650 may include a number of buttons 652-656 for selecting a provider that of a service that an institution selects to implement in the environment. Selectable button 652 may be associated with a payment application and/or. Selectable button 654 may be associated with an artificial intelligence (“AI”) engine (e.g., AI engine). Selecting a provider may select one or more component buttons (e.g., 616-630) or one or more solution buttons (e.g., 636-640).

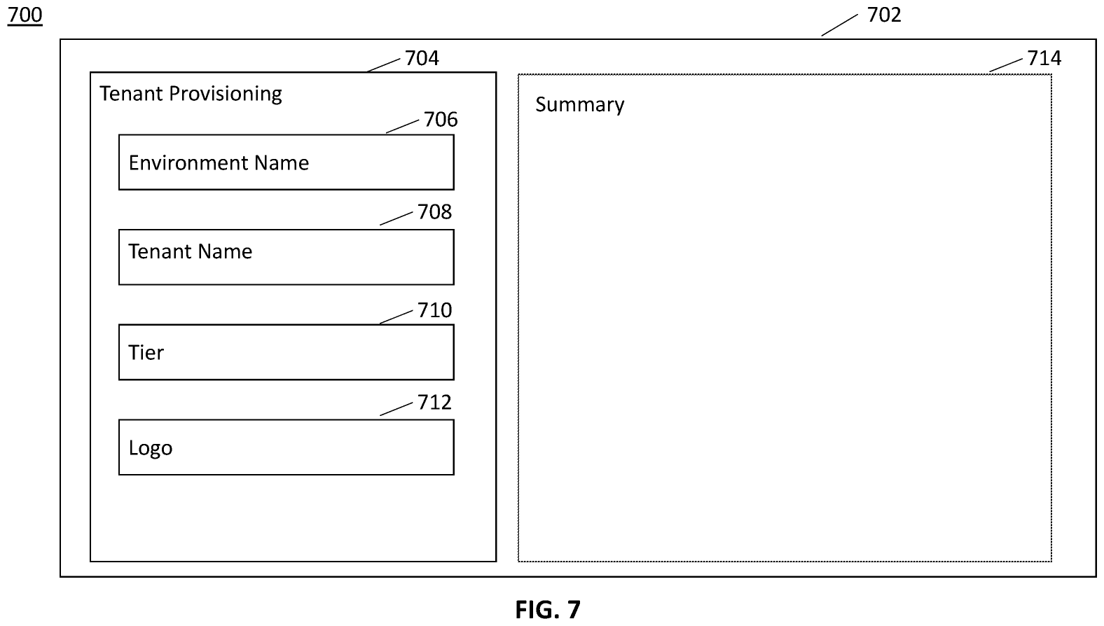

FIG. 7 illustrates an exemplary embodiment of a user interface associated with generating a platform. The user interface may be part of an application installed on a computing device (e.g., individual device 102). It is contemplated that the user interface may be implemented as part of a website or web portal that can be accessed by a user, for example, when the user uses a browsing application.

FIG. 7 illustrates user interface 700 displaying information related to generating an environment. User interface 700 may include selection interface 702. Selection interface 702 may include tenant provisioning section 704 and summary 714. Tenant provisioning section 704 may include input sections, such as environment name input 706, tenant name input 708, tier input 710, and logo input 712. Environment name input 706 may be used to select a name for the environment. Tenant name input 708 may be used to select a name for a tenant. The tenant may reflect the name of an institution that the environment is associated with. Tier input 710 may be used to select a tier. The tier may be associated with a level of service, redundancy, priority, or a speed associated with one or more network or database components. Logo input 712 may be used to input a logo associated with the institution via upload. Summary 714 may be configured to display information associated with inputs and selections from tenant provisioning section 704.

It will be apparent to those skilled in the art that various modifications and variations can be made to the environment instantiation platform. While illustrative embodiments have been described herein, the scope of the invention includes any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit of the invention being indicated by the following claims and their full scope of equivalents.

1. A system for generating an environment, the system comprising:
at least one processor; and
at least one non-transitory memory storing instructions to perform operations when executed by the at least one processor including:
receiving, from a user device, a request to establish an environment including functionality of an application of the environment;
generating a parameter based on the functionality of the application;
determining if the parameter is above a threshold;
preparing a network for an interaction based on the parameter if the parameter is above the threshold;
preparing a server to receive, store, and provide data for the application; and
generating code based on the application for operation on the server.

2. The system of claim 1, the operations further comprising:
generating an end-user interface based on the application.

3. The system of claim 1, wherein the parameter is a network measure based on a capability of the application.

4. The system of claim 3, wherein the environment operates on a virtual network that includes at least one of a management interface, a testing interface, and a development interface.

5. The system of claim 1, wherein the interaction is a use of an application.

6. The system of claim 1, the operations further comprising:
monitoring the network to determine if the parameter is above a threshold; and
updating the network if the parameter is above the threshold. A system for generating an environment, the system comprising:
at least one processor; and
at least one non-transitory memory storing instructions to perform operations when executed by the at least one processor including:
receiving an identification of an application capability from a user interface;
determining an infrastructure parameter based on the application capability;
generating an environment based on the application capability; and
configuring the environment based on the infrastructure parameter.

8. The system of claim 7, the operations further comprising:
monitoring an event of the environment;
updating the configuration of the environment based on the event.

9. The system of claim 8, wherein the event is exceeding a load capacity of the environment.

10. The system of claim 7, the operations further comprising:
monitoring a load capacity of the environment; and
updating the configuration of the environment based on the load capacity.

11. The system of claim 7, the operations further comprising:
monitoring the use of the application capability of the system to determine the use of a resource; and
updating the resource based on the use of the application capability.

12. The system of claim 7, the operations further comprising:
monitoring the use of the application capability of the system to determine the use of a resource; and
determining an update for the resource based on the use of the application capability; and
sending the update to the user interface.

13. The system of claim 7, wherein the infrastructure parameter is a number of accounts.

14. A method for generating a platform, the method comprising steps of:
receiving an identification of an application capability from a user interface;
determining an infrastructure parameter based on the application capability;
generating an environment based on the application capability; and
configuring the environment based on the infrastructure parameter.

15. The method of claim 14, the operations further comprising steps of:
monitoring an event of the platform;
updating the configuration of the platform based on the event.

16. The method of claim 15, wherein the event is exceeding a load capacity of the platform.

17. The method of claim 14, the operations further comprising steps of:
monitoring a use of an application in another environment associated with a second user;
sending an update to the user interface to update the environment with the application.

18. The method of claim 14, further comprising steps of:
monitoring the use of the application capability of the system to determine the use of a resource; and
updating the resource based on the use of the application capability.

19. The method of claim 14, further comprising steps of:
monitoring the use of the application capability of the system to determine the use of a resource; and
determining an update for the resource based on the use of the application capability; and
sending the update to the user interface.

20. The method of claim 14, wherein the infrastructure parameter is a number of accounts.
